(19) United States
(12) Patent Application Publication
(10) Pub. No.: US 2017/0138387 A1
(43) Pub. Date: May 18, 2017

(54) BOLT, NUT, AND STRAIN MEASUREMENT SYSTEM

(71) Applicant: SANNOHASHI CORPORATION, Yashio-shi (JP)

(72) Inventors: Fumitaka SAIGO, Saitama (JP); Shunsuke TAKAHASHI, Tokyo (JP)

(21) Appl. No.: 15/160,330

(22) Filed: May 20, 2016

Related U.S. Application Data
(63) Continuation of application No. PCT/JP2013/081551, filed on Nov. 22, 2013.

(51) Int. Cl. F16B 31/02; G01L 1/24; G01L 1/12

(52) U.S. Cl. CPC F16B 31/02; G01L 1/125; G01L 1/241; F16B 2031/022

(57) ABSTRACT

A head of a bolt includes a deformed portion that has a smaller thickness in an axial direction of a shank or a smaller value of Young's modulus than other portion of the head, and that is configured to be deformed more than the other portion by axial force of the shank. A detection unit of the bolt is configured to detect strain on the deformed portion depending on the axial force of the shank. The deformed portion includes a thin portion that has a thickness smaller than a largest thickness of the head in the axial direction of the shank. The head includes a recessed portion having a bottom plate serving as the thin portion. The bottom plate is positioned on an axis of the shank. The detection unit is positioned on the axis of the shank and is configured to detect strain on the bottom plate.

### CROSS REFERENCE TO RELATED APPLICATION

This application is a continuation application of PCT/JP2013/081551 of an international application designating the United States of America filed on Nov. 22, 2013. The entire content of the PCT application is incorporated herein by reference.

### TECHNICAL FIELD

The present invention relates to a bolt and a nut, the fastened state of which can be detected.

### BACKGROUND

Japanese Patent Application Publication No. H11-118637 proposes a bolt, the fastened state of which can be detected.

In the bolt disclosed in Japanese Patent Application Publication No. H11-118637, a long hole is formed at the center of a shank and a strain gauge is inserted/fixed in the hole such that axial force of the shank is detected by detecting strain on the shank with the strain gauge.

### SUMMARY

The bolt disclosed in Japanese Patent Application Publication No. H11-118637 requires cleaning after forming the long hole in the bolt, and the strain gauge to be inserted in the long hole. Thus, manufacturing of this bolt involves a complex work and a long work time that lead to a high cost.

In view of the foregoing, it is an object of the present invention to provide a bolt and a nut that can achieve highly accurate detection of axial force of a shank, and require no complex work or long work time.

This and other objects of the present invention will be attained by providing a bolt including a shank, a head, and a detection unit. The head is disposed on one end of the shank, and includes a deformed portion that has a smaller thickness in an axial direction of the shank or a smaller value of Young's modulus than other portion of the head, and that is configured to be deformed more than the other portion by axial force of the shank. The detection unit is configured to detect strain on the deformed portion depending on the axial force of the shank. The deformed portion includes a thin portion that has a thickness smaller than a largest thickness of the head in the axial direction of the shank. The head includes a recessed portion having a bottom plate serving as the thin portion. The bottom plate is positioned on an axis of the shank. The detection unit is positioned on the axis of the shank and is configured to detect strain on the bottom plate.

In another aspect of the invention, there is provided a bolt including a shank, a head, and a detection unit. The head is disposed on one end of the shank, and includes a deformed portion that has a smaller thickness in an axial direction of the shank or a smaller value of Young's modulus than other portion of the head, and that is configured to be deformed more than the other portion by axial force of the shank. The detection unit is configured to detect strain on the deformed portion depending on the axial force of the shank. The deformed portion includes a thin portion that has a thickness smaller than a largest thickness of the head in the axial direction of the shank. The head includes a flange that serves as the thin portion, extends in a radial direction of the shank, and has an opposite surface positioned on a side opposite to a contact surface that comes into contact with an object to be fastened. The detection unit is configured to detect strain on the opposite surface of the flange.

In another aspect of the invention, there is provided a bolt including a shank, a head, and a detection unit. The head is disposed on one end of the shank, and includes a deformed portion that has a smaller thickness in an axial direction of the shank or a smaller value of Young's modulus than other portion of the head, and that is configured to be deformed more than the other portion by axial force of the shank. The detection unit is configured to detect strain on the deformed portion depending on the axial force of the shank. The head includes a recessed portion. The deformed portion is a leaf spring as a portion provided independently from the recessed portion and having the small value of Young's modulus, and is disposed in the recessed portion in such a manner as to be deformed in accordance with deformation of the recessed portion. The detection unit is configured to detect strain on the leaf spring.

In another aspect of the invention, there is provided a nut including a nut main body and a detection unit. The nut main body is fastened to a fastening bolt including a shank, and includes a deformed portion that has a smaller thickness in an axial direction of the nut main body or a smaller value of Young's modulus than other portion of the nut main body, and that is configured to be deformed more than the other portion by axial force of the shank. The detection unit that is configured to detect strain on the deformed portion corresponding to the axial force of the shank.

In another aspect of the invention, there is provided the above bolt and a measurement device that is configured to generate a magnetic flux and receive a wireless signal. The detection unit includes: a power reception unit that is configured to generate power in accordance with the magnetic flux; a strain detection element that is configured to change an electrical characteristic in accordance with the strain; and a transmission unit that is configured to be operated by the power, generate a signal corresponding to the electrical characteristic, and wirelessly transmit the signal to the measurement device. The measurement device includes: a power transmission unit that is configured to transmit power to the power reception unit by varying the magnetic flux; and a power reception unit that is configured to wirelessly receive the signal from the transmission unit.

### BRIEF DESCRIPTION OF THE DRAWINGS

In the drawing:

FIG. 1A is a top view of a bolt according to a first embodiment;

FIG. 1B is a front view of the bolt according to the first embodiment;

FIG. 2 is a cross-sectional view of a portion around a head of the bolt according to the first embodiment;

FIG. 3 illustrates a state where objects to be fastened are fastened by the bolt according to the present embodiment;

FIG. 4 is a cross-sectional view of a portion around a head of a bolt according to the second embodiment;

FIG. 5A is a top view of a bolt according to the third embodiment;

FIG. 5B is a cross-sectional view of a portion around a head of the bolt according to the third embodiment;

FIG. 6 is a cross-sectional view of a portion around a head of a bolt according to the fourth embodiment;

FIG. 7A illustrates a state where an object to be fastened is fastened by a nut and a bolt according to the fifth embodiment;

FIG. 7B is a top view of the nut according to the fifth embodiment;

FIG. 8 is a bolt according to a modification to the embodiment;

FIG. 9 is a bolt according to another modification of the embodiment;

FIG. 10 is a bolt according to another modification of the embodiment;

FIG. 11 is a bolt according to another modification of the embodiment;

FIG. 12 is a nut according to a modification of the embodiment;

FIG. 13A is a top view of a bolt according to another modification of the embodiment;

FIG. 13B is a cross-sectional view of a portion around a head of the bolt according another modification to the embodiment;

FIG. 14 is a block diagram illustrating a configuration of a strain detection unit;

FIG. 15 is a circuit diagram illustrating a configuration of a power reception circuit;

FIG. 16 is a circuit diagram illustrating a configuration of a signal processing circuit;

FIG. 17 is a circuit diagram illustrating a configuration of a data switching circuit;

FIG. 18 is a block diagram illustrating a configuration of a measurement device;

FIG. 19 is a circuit diagram illustrating a configuration of the modification of a signal processing circuit.

### DETAILED DESCRIPTION

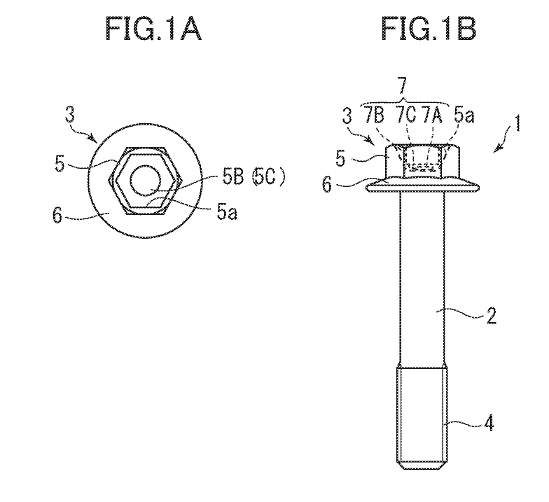

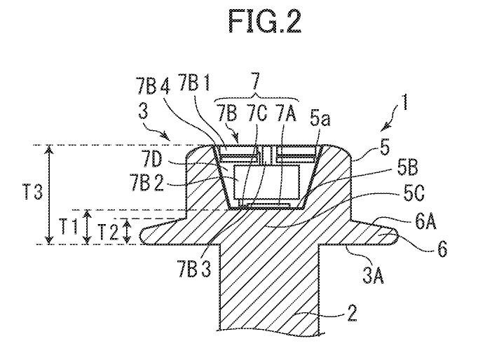

A bolt according to an embodiment of the present invention will be described with reference to the drawings. FIG. 1A is a top view of a bolt 1 according to a first embodiment. FIG. 1B is a front view of the bolt 1 according to the first embodiment. In FIG. 1A, a strain detection unit 7 is omitted. FIG. 2 is a cross-sectional view of a portion around a head of the bolt 1 according to the first embodiment.

As illustrated in FIG. 1, the bolt 1, made of a steel material, includes a shank 2 having a cylindrical shape, a head 3 provided on one end of the shank 2, and the strain detection unit 7. A male screw 4 is formed on a side of the other end of the shank 2. The head 3 includes a recessed portion 5 with an outer circumference having a hexagonal pillar shape and a flange 6. As illustrated in FIG. 2, the head 3 has a contact surface 3A that comes into contact with an object to be fastened. A recess 5a is formed in the recessed portion 5, and the recessed portion 5 includes a bottom plate 5C serving as a bottom surface 5B of the recess 5a. The bottom plate 5C corresponds to a thin portion and to a deformed portion. The outer shape of the recessed portion 5 is not limited to the hexagonal shape, and may be a dodecagonal shape or a hexalobular shape.

The flange 6 is provided on the outer circumference of the recessed portion 5 and radially extends in a radial direction of the shank 2 from the outer circumference of the recessed portion 5. The flange 6 includes an opposite surface 6A on a side opposite to the contact surface 3A in an axial direction of the shank 2. A thickness T1 of the bottom plate 5C and a largest thickness T2 of the flange 6 are smaller than a largest thickness T3 of the head 3. The flange 6 corresponds to the thin portion and to the deformed portion.

The strain detection unit 7 is disposed in the recess 5a. The strain detection unit 7 includes a resistance strain gauge 7A, an output circuit 7B, and a signal line 7C. The resistance strain gauge 7A, which is a foil gauge formed of a metal foil adhered on a base material, is adhered on the bottom surface 5B with adhesive, and detects strain on the bottom plate 5C. The resistance strain gauge 7A, the output circuit 7B, and the signal line 7C are integrated by a resin piece 7D, and is fixed on the recess 5a with adhesive.

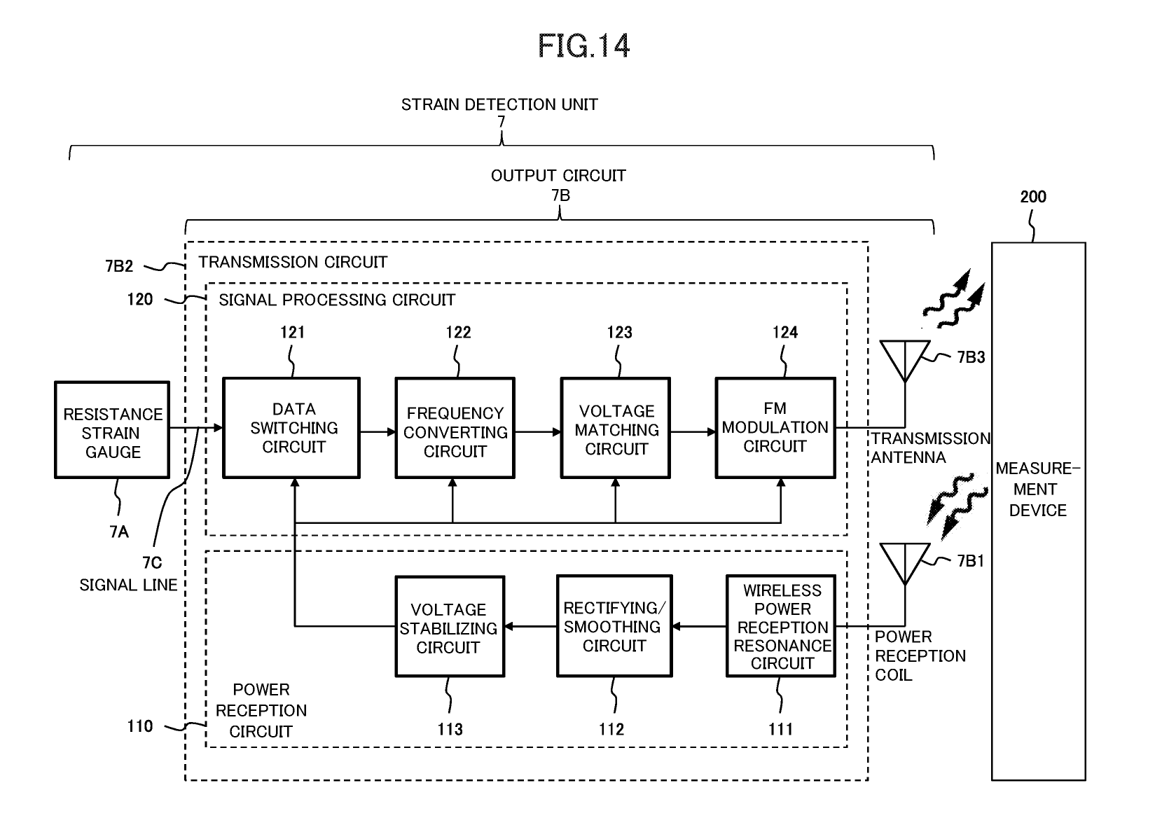

The output circuit 7B includes a power reception coil 7B1, a transmission circuit 7B2, a transmission antenna 7B3, and a magnetic force blocking plate 7B4 (see FIG. 14). The power reception coil 7B1 has an annular shape and generates current upon receiving magnetic force from the outside. The transmission circuit 7B2 detects a resistance of the resistance strain gauge 7A upon receiving the current from the power reception coil 7B1, and performs conversion to obtain a signal indicating the resistance. The transmission antenna 7B3 transmits the signal thus obtained by the conversion to the outside. The magnetic force blocking plate 7B4 blocks the magnetic force from the outside.

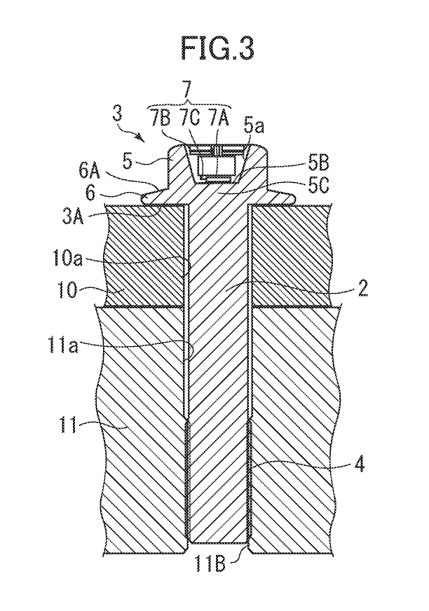

FIG. 3 illustrates a state where objects to be fastened are fastened by the bolt 1 according to the present embodiment. A first insertion hole 10a is formed in a first fastened object 10. A second insertion hole lla is formed in a second fastened object 11. A female screw 11B is formed on an inner circumference surface, defining the second insertion hole 11a, and on one side of the second fastened object 11.

The shank 2 of the bolt 1 is inserted into the first and the second insertion holes 10a and 11a, and the male screw 4 of the bolt 1 and the female screw 11B of the second fastened object 11 are screwed together. Thus, the first and the second fastened objects 10 and 11 are fastened by the bolt 1. When the bolt 1 is tightened, a fastening tool, having an inner circumference shape corresponding to the outer circumference shape of the recessed portion 5 rotates the bolt 1 while covering the recessed portion 5, so that the male screw 4 of the bolt 1 and the female screw 11B of the second fastened object 11 are screwed together.

In a state where the first and the second fastened objects 10 and 11 are fastened by the bolt 1, the contact surface 3A of the head 3 presses the first fastened object 10. The head 3 receives counter force, with respect to the pressing, from the first fastened object 10, and thus axial force is generated in the shank 2. The head 3 is pulled toward the first fastened object 10 by the axial force. As a result, stress is concentrated on the bottom plate 5C and the flange 6 having the thicknesses smaller than the largest thickness T3 of the head 3. Thus, these portions are more deformed than other portions of the head 3. In other words, the stress based on the axial force of the shank 2 is concentrated on the thin portions, so that the thin portions function as the deformed portions that are more deformed than the other portions of the head 3.

The resistance of the resistance strain gauge 7A changes in accordance with strain on the bottom plate 5C (bottom surface 5B). An initial resistance of the resistance strain gauge 7A after the fastening is detected, with a signal corresponding to the resistance of the resistance strain gauge 7A output from the output circuit 7B. More specifically, a magnetic field toward the power reception coil 7B1 is generated by a measurement device 200 (see FIG. 14), so that current is generated by the power reception coil 7B1 and supplied to the transmission circuit 7B2. The transmission circuit 7B2 thus supplied with the current detects the resistance of the resistance strain gauge 7A, and performs conversion to obtain the signal indicating the resistance. The transmission antenna 7B3 transmits the signal thus obtained by the conversion to the outside. The measurement device 200 receives the signal thus transmitted. In this manner, the strain detection unit 7 detects and outputs the strain on the bottom plate 5C (bottom surface 5B).

After a predetermined period of time has elapsed after the first and the second fastened objects 10 and 11 have been fastened by the bolt 1, the resistance of the resistance strain gauge 7A is detected to determine whether the bolt 1 is appropriately fastened.

When the bolt 1 has loosened, the axial force of the shank 2 is reduced and the amount of strain on the bottom plate 5C is changed accordingly. As a result, the resistance of the resistance strain gauge 7A changes. When the bolt 1 is appropriately fastened, there is almost no change in the axial force of the shank 2 and almost no change in the amount of strain on the bottom plate 5C. Thus, there is almost no change in the resistance of the resistance strain gauge 7A.

Thus, the fastened state of the bolt 1 can be detected by comparing the initial resistance of the resistance strain gauge 7A after the fastening and the resistance of the resistance strain gauge 7A after the predetermined period of time has elapsed. More specifically, it can be determined that the bolt 1 has loosened when the detected resistance largely differs from the initial resistance of the resistance strain gauge 7A after the fastening. It can be determined that the bolt 1 is appropriately fastened, when the detected resistance does not largely differ from the initial resistance of the resistance strain gauge 7A after the fastening.

As described above, in the bolt 1 according to the present invention, the head 3 has the bottom plate 5C (deformed portion) with a thickness, in the axial direction of the shank 2, smaller than the other portions and thus is more deformed by the axial force of the shank 2 than the other portions. The strain detection unit 7 detects the strain on the bottom plate 5C corresponding to the axial force of the shank 2. The thickness of the bottom plate 5C is smaller than the largest thickness of the head 3, in the axial direction of the shank 2. Thus, the strain on the portion is detected with the portion that is sensitive to the change in the axial force of the shank 2 formed in the head 3. Thus, the strain detection unit 7 can accurately and easily detect the change in the axial force of the shank 2, whereby the fastened state of the bolt 1 can be accurately confirmed.

The strain detection unit 7 detects the strain on the bottom plate 5C, with the recessed portion 5, including the bottom plate 5C as the thin portion, provided in the head 3. The recessed portion 5 can be easily formed in the head 3, whereby the bolt 1 that can have the fastened state accurately confirmed and involves no complex operation, long operation time, or high cost can be obtained.

Next, the strain detection unit 7 will be described in detail.

FIG. 14 is a block diagram illustrating a configuration of the strain detection unit 7. As described above, the output circuit 7B of the strain detection unit 7 includes the power reception coil 7B1, the transmission circuit 7B2, and the transmission antenna 7B3. The transmission circuit 7B2 includes a power reception circuit 110 and a signal processing circuit 120. The power reception coil 7B1 generates alternate current (AC) power in accordance with the variation of the magnetic flux from the measurement device 200. The power reception circuit 110 is connected to the power reception coil 7B1, and converts the AC power, supplied from the power reception coil 7B1, into direct current (DC) power. The signal processing circuit 120 is connected to the power reception circuit 110, the resistance strain gauge 7A, and the transmission antenna 7B3, and is operated by the power from the power reception circuit 110. The signal processing circuit 120 generates the signal corresponding to the resistance of the resistance strain gauge 7A, and wirelessly transmits the signal thus generated to the measurement device 200 through the transmission antenna 7B3. The power reception circuit 110 and the like correspond to a power reception unit, and the transmission circuit 7B2 and the like correspond to a transmission unit. The resistance strain gauge 7A and the like correspond to a strain detection element. In this case, the resistance corresponds to an electrical characteristic. An element such as a piezoelectric element that changes an electrical characteristic, different from the strain, in accordance with the strain may be used as the strain detection element.

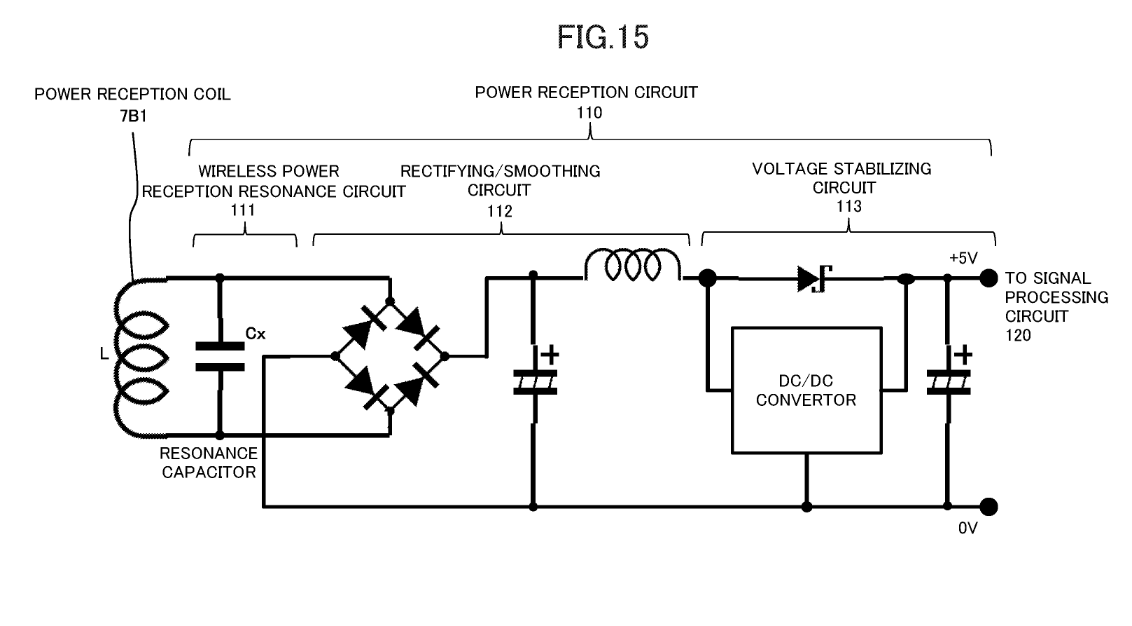

FIG. 15 is a circuit diagram illustrating a configuration of the power reception circuit 110. The power reception circuit 110 includes a wireless power reception resonance circuit 111, a rectifying/smoothing circuit 112, and a voltage stabilizing circuit 113. The wireless power reception resonance circuit 111 includes a resonance capacitor connected to the power reception coil 7B1, and thus forms a resonance circuit and generates AC power. For example, the rectifying/smoothing circuit 112 includes a diode full wave rectifier circuit, and converts the AC power from the wireless power reception resonance circuit 111 into DC power through rectifying and smoothing. For example, the voltage stabilizing circuit 113 includes a DC/DC converter, and converts the DC power from the rectifying/smoothing circuit 112 into predetermined voltage.

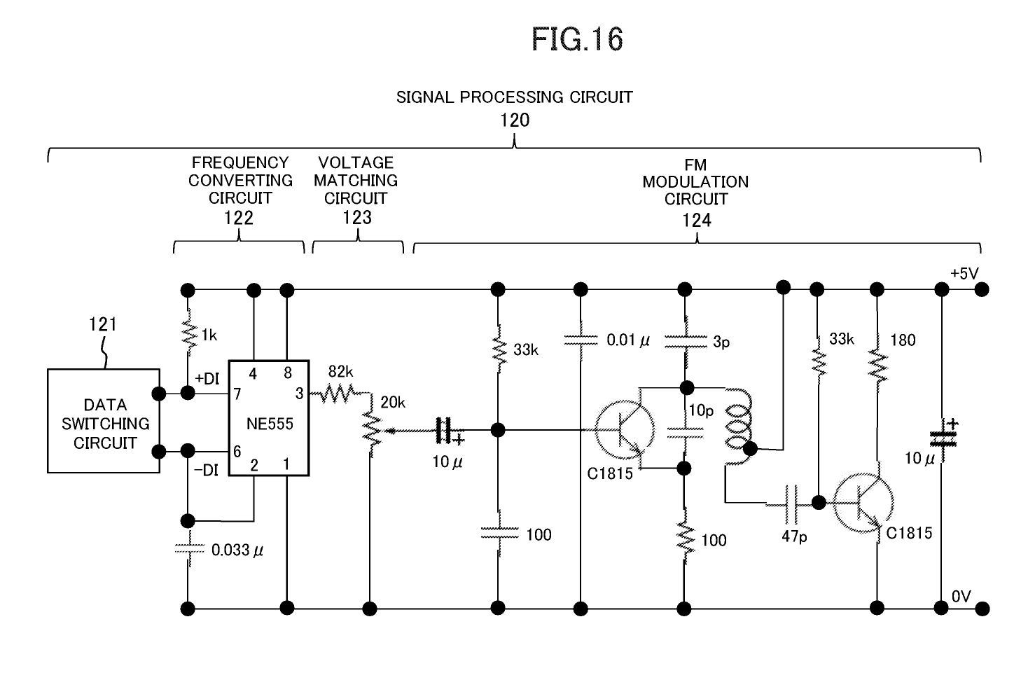

FIG. 16 is a circuit diagram illustrating a configuration of the signal processing circuit 120. The signal processing circuit 120 includes a data switching circuit 121, a frequency converting circuit 122, a voltage matching circuit 123, and an FM modulation circuit 124. The data switching circuit 121 is connected to the resistance strain gauge 7A, and includes several resistors. The data switching circuit 121 switches among the several resistors including the resistance strain gauge 7A. The frequency converting circuit 122 includes a capacitor and a timer IC (for example, NE555) connected in series with the resistors of the data switching circuit 121, and forms a CR oscillator to generate an AC signal having a frequency corresponding to the resistance of the data switching circuit 121. Thus, the frequency output from the frequency converting circuit 122 increases as the resistance of the resistance strain gauge 7A or the like increases. The voltage matching circuit 123 converts the voltage of the AC signal output from the frequency converting circuit 122. The FM modulation circuit 124 performs frequency modulation on carrier waves having the predetermined frequency with the AC signal output from the voltage matching circuit 123, to generate a measurement signal and transmits the measurement signal to the measurement device 200 through the transmission antenna 7B3. For example, the transmission antenna 7B3 is a coil in the FM modulation circuit 124. The transmission antenna 7B3 may be connected externally to the transmission circuit 7B2.

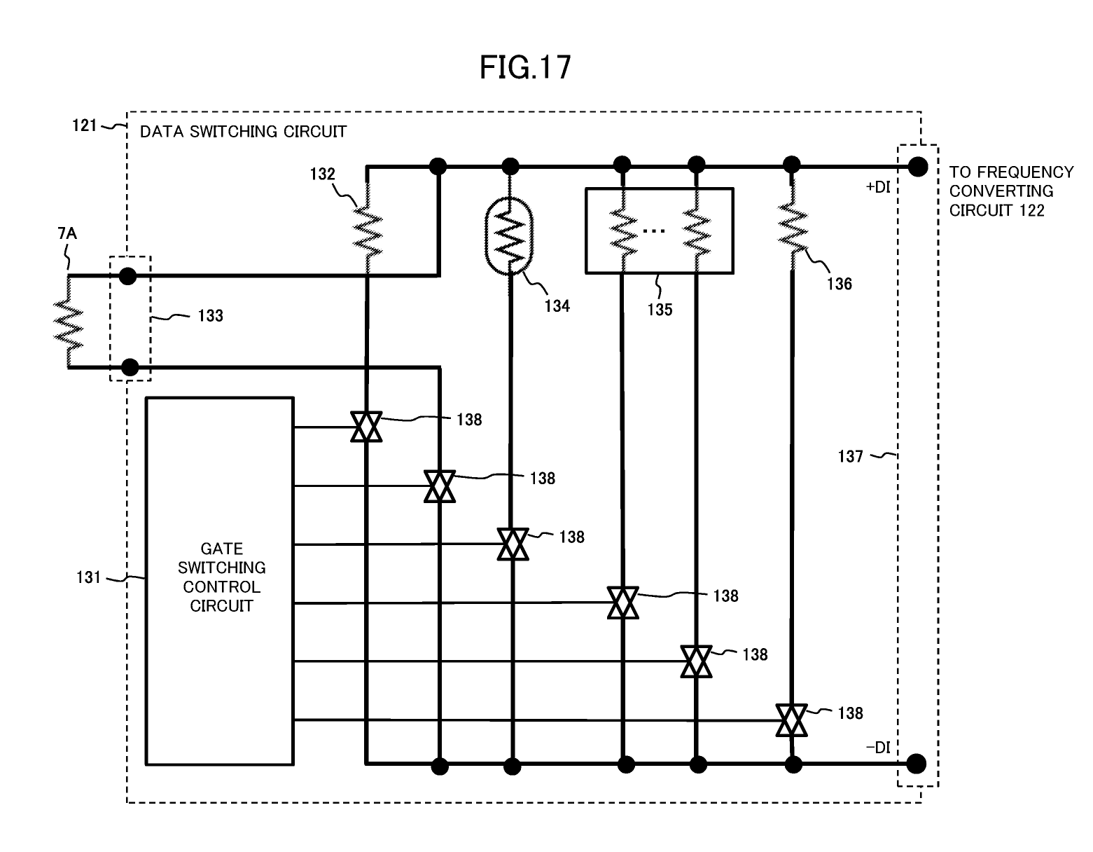

FIG. 17 is a circuit diagram illustrating a configuration of the data switching circuit 121. The data switching circuit 121 includes a gate switching control circuit 131, a start bit generation circuit 132, a resistance strain gauge connecting terminal 133, a thermistor 134, a bolt ID generating circuit 135, a stop bit generating circuit 136, an output terminal 137, and a plurality of gates 138. The thermistor 134 and the like correspond to a temperature measurement unit. The bolt ID generating circuit 135 and the like correspond to an identification information storage unit.

One terminal of each of the plurality of gates 138 is connected to a corresponding one of the start bit generation circuit 132, the resistance strain gauge connecting terminal 133, the thermistor 134, the bolt ID generating circuit 135, and the stop bit generating circuit 136. The other terminal of each of the plurality of gates 138 is connected to the output terminal 137. The output terminal 137 is connected to an input of the frequency converting circuit 122. The gate switching control circuit 131 selects the plurality of gates 138 one by one at a predetermined interval, and turns ON the gate 138 thus selected.

The start bit generation circuit 132 has a predetermined resistance indicating the start of transmission information. The resistance strain gauge connecting terminal 133 is connected to the resistance strain gauge 7A. The thermistor 134 has a resistance depending on the temperature of a portion around the resistance strain gauge 7A. The bolt ID generating circuit 135 has a resistance corresponding to a bolt ID (identification information) set in advance for each bolt 1. The bolt ID generating circuit 135 may have a resistance corresponding to the bit number of the bolt ID. The bolt ID generating circuit 135 may include a DIP switch so that the resistance can be changed. The stop bit generating circuit 136 has a predetermined resistance indicating the end of the transmission information.

The gate switching control circuit 131 and the plurality of gates 138 operate in such a manner that the resistance indicating the start bit, the resistance of the resistance strain gauge 7A, the resistance indicating the temperature, the resistance indicating the bolt ID, and the resistance indicating the stop bit are switched from one to another in sequence to establish connection between the output terminals 137 of the data switching circuit 121. Thus, the strain detection unit 7 periodically transmits a signal, having a frequency corresponding to each of the plurality of resistances switched from one to another by the data switching circuit 121, as measurement information.

Next, the measurement device 200 will be described. The measurement device 200 wirelessly transmits power to the strain detection unit 7, and measures the strain based on a signal transmitted from the strain detection unit 7.

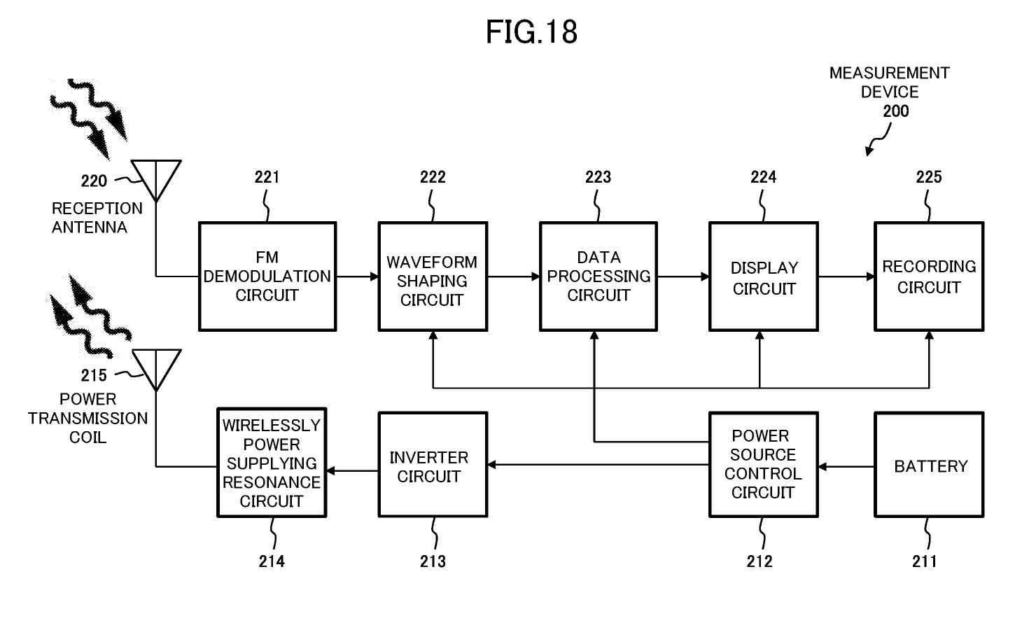

FIG. 18 is a block diagram illustrating a configuration of the measurement device 200. The measurement device 200 includes a battery 211, a power source control circuit 212, an inverter circuit 213, a wirelessly power supplying resonance circuit 214, a power transmission coil 215, a reception antenna 220, an FM demodulation circuit 221, a waveform shaping circuit 222, a data processing circuit 223, a display circuit 224, and a recording circuit 225. The battery 211, the power source control circuit 212, the inverter circuit 213, the wirelessly power supplying resonance circuit 214, the power transmission coil 215, and the like correspond to a power transmission unit. The FM demodulation circuit 221, the waveform shaping circuit 222, the data processing circuit 223, and the like correspond to a power reception unit.

The battery 211 supplies power. An external power source may be used instead of the battery 211. The power source control circuit 212 converts the power supplied from the battery 211 and supplies the resultant power to components of the measurement device 200. The inverter circuit 213 converts the DC power supplied from the power source control circuit 212 into AC power having a predetermined frequency. The wirelessly power supplying resonance circuit 214 generates and varies the magnetic flux in the power transmission coil 215 in accordance with the AC power supplied from the inverter circuit 213.

The reception antenna 220 receives the measurement signal transmitted from the strain detection unit 7. The FM demodulation circuit 221 demodulates the measurement signal thus received, and thus generates a signal indicating the resistance. The waveform shaping circuit 222 shapes the waveform of the signal obtained by the demodulation by the FM demodulation circuit 221. The data processing circuit 223 performs A/D conversion on the signal as a result of the shaping, and acquires each the plurality of resistances, switched from one to another by the data switching circuit 121, from the signal as a result of the conversion. The data processing circuit 223 recognizes the start of the measurement information from the acquired start bit, recognizes the resistance of the resistance strain gauge 7A, the resistance of the thermistor 134, and the bolt ID, and recognizes the end of the measurement information from the acquired stop bit. The data processing circuit 223 stores relationship between the resistance of the resistance strain gauge 7A and the resistance of the thermistor 134, and calculates the strain with the resistance of the resistance strain gauge 7A corrected based on the relationship and the resistance of the thermistor 134. Thus, the strain can be more accurately measured, with the temperature characteristic corrected for the measurement result obtained by the resistance strain gauge 7A.

The display circuit 224 displays the bolt ID, the amount of strain, and the like based on an output from the data processing circuit 223. The recording circuit 225 records the bolt ID, the amount of strain, and the like based on the output from the data processing circuit 223. For example, the recording circuit 225 is a hard disk drive (HDD), a flash memory, or the like.

A measurer moves the measurement device 200 close to the bolt 1 that has just been fastened. Thus, the measurement device 200 supplies power to the strain detection unit 7 of the bolt 1, and the strain detection unit 7 transmits the measurement information to the measurement device 200. The measurement device 200 records the strain obtained from the measurement information. Then, after a predetermined period of time has elapsed, the measurer moves the measurement device 200 close to the bolt 1, so that the strain measured is recorded as in the point right after the fastening is achieved. The changed amount of the strain is calculated by comparing an initial strain after the fastening and the strain obtained after the predetermined period of time has elapsed. It can be determined that the bolt 1 has loosened when the changed amount exceeds a predetermined threshold. For a certain bolt ID, the measurement device 200 may record the strain obtained in the previous measurement, calculate the difference between the strain obtained by the previous measurement and the strain obtained by the current measurement, and determine whether the difference therebetween exceeds a predetermined threshold.

In this configuration, the strain detection unit 7 transmits information indicating the resistance of the resistance strain gauge 7A and the resistance of the thermistor 134. The measurement device 200 corrects the strain based on the temperature. Thus, the strain detection unit 7 needs not to have a temperature compensation function for the strain. Thus, the measurement of the strain on the bottom plate 5C can be achieved at a low cost.

The measurement device 200 may calculate the axial force based on the measurement information, and record the axial force. In such a case, the measurement device 200 measures and records initial axial force Fo after the fastening, which is the axial force right after the bolt 1 is fastened, measures axial force Fi obtained after a predetermined maintenance time has elapsed, and calculates an axial force difference Fo−Fi. The measurement device 200 determines that the bolt 1 has loosened when the axial force difference exceeds a positive axial force difference threshold.

When the first fastened object 10 and the second fastened object 11 are fastened by a plurality of bolts including the bolt 1, the measurement device 200 may further determine whether the axial force difference falls below a negative axial force difference threshold. The axial force difference below the negative axial force difference threshold might be indicating that bolts other than the bolt 1 in the plurality of bolts have loosened and the load that had been imposed on such the bolts is now imposed on the bolt 1. Thus, the bolt 1 can be used for detecting loosening of other bolts around the bolt 1. When the axial force difference falls below the negative axial force difference threshold, the measurer reexamines all the bolts other than the bolt 1. Thus, the strain detection unit 7 needs not to be provided to all of the plurality of bolts, whereby an attempt to achieve cost reduction is facilitated.

Next, a modification of the signal processing circuit 120 is described.

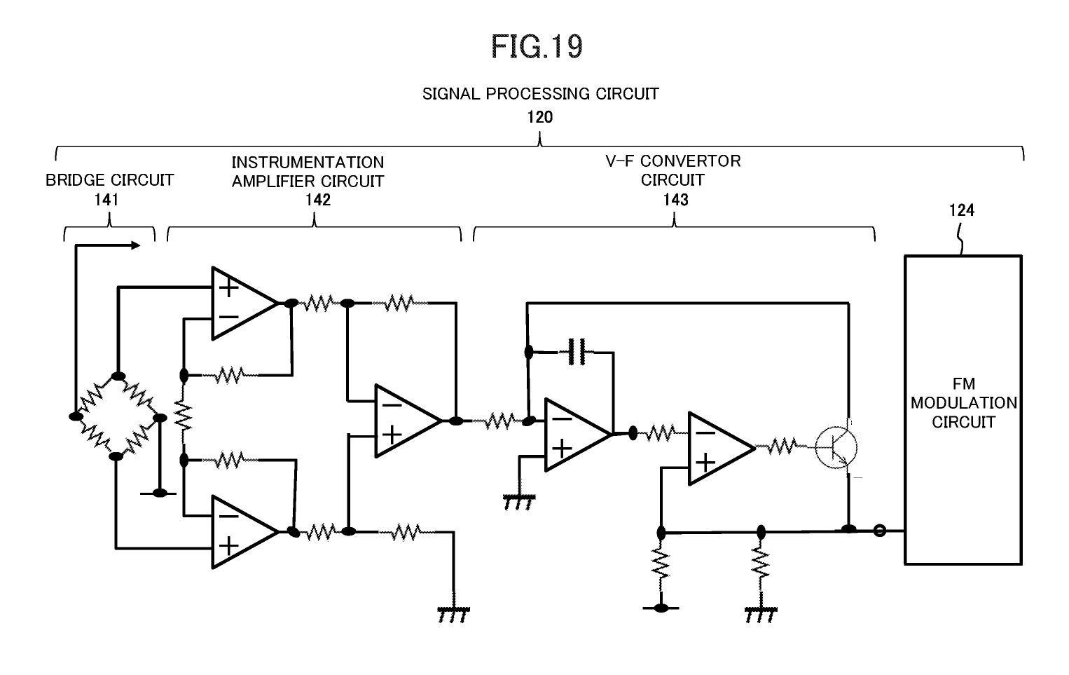

FIG. 19 is a circuit diagram illustrating a configuration of the modification of the signal processing circuit 120. Portions that are the same as those in the signal processing circuit 120 described above are denoted with the same reference numerals, and the description thereof will be omitted. Thus, only the difference will be described. The signal processing circuit 120 includes a bridge circuit 141, an instrumentation amplifier circuit 142, a V-F converter circuit 143, and the FM modulation circuit 124.

The bridge circuit 141 includes four resistors including the resistance strain gauge 7A, and outputs voltage corresponding to a change in the resistance of the resistance strain gauge 7A. The bridge circuit 141 may include a single resistance strain gauge 7A, two resistance strain gauges 7A, or four resistance strain gauges 7A. The instrumentation amplifier circuit 142 includes three operation amplifiers, and amplifies the output from the bridge circuit 141. The V-F converter circuit 143 performs integrating, comparing, and switching on the voltage output from the instrumentation amplifier circuit 142 to generate a square wave signal having a frequency corresponding to the voltage. Thus, the frequency of the output from the V-F converter circuit 143 increases as the resistance of the resistance strain gauge 7A increases. The output from the V-F converter circuit 143 is modulated by the FM modulation circuit 124, and transmitted through the transmission antenna 7B3.

The strain detection unit 7 uses the bridge circuit 141 and thus can measure minute strain.

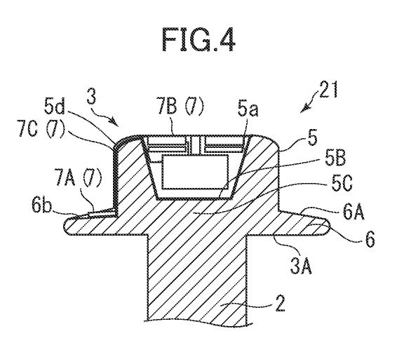

Next, a bolt 21 according to a second embodiment of the present invention will be described. Components that are the same as the counterparts in the first embodiment are denoted with the same reference numerals, and the description thereof is omitted. Thus, only the difference will be described. FIG. 4 is a cross-sectional view of a portion around a head of the bolt according to the second embodiment.

As illustrated in FIG. 4, in the present embodiment, a dent 6b is partially formed on the opposite surface 6A of the flange 6. The resistance strain gauge 7A is adhered on the dent 6b with adhesive. Thus, the resistance strain gauge 7A is contained in the dent 6b so as not to hinder the tightening of the bolt 1. The output circuit 7B is disposed on the bottom plate 5C.

A connecting groove 5d is formed in the recessed portion 5 and connects between the recess 5a and the dent 6b. The resistance strain gauge 7A and the output circuit 7B are connected to each other through the signal line 7C routed along the connecting groove 5d. As described in the first embodiment, the largest thickness T2 (FIG. 2) of the flange 6 is set to be smaller than the largest thickness T3 (FIG. 2) of the head 3.

As in the case of the bolt 1 according to the first embodiment, in a state where the first and the second fastened objects 10 and 11 (FIG. 3) are fastened by the bolt 21, the stress is concentrated on the flange 6 having a thickness smaller than the largest thickness T3 of the head 3, due to the axial force produced in the shank 2, and thus the flange 6 is more deformed than other portions of the head 3, as in the case of the bolt 1. In other words, the stress is concentrated on a portion around the boundary between the recessed portion 5 and the flange 6 having a thickness smaller than the largest thickness T3 of the head 3, and thus the portion around the boundary between the recessed portion 5 and the flange 6 is more deformed than the other portions.

The resistance of the resistance strain gauge 7A changes in accordance with the strain on the flange 6. The initial resistance of the resistance strain gauge 7A after the fastening is detected with an electric signal based on the resistance of the resistance strain gauge 7A output from the output circuit 7B. Thus, the strain on the flange 6 is detected as the resistance by the strain detection unit 7.

As in the case of the bolt 1 according to the first embodiment, in the bolt 21 according to the present embodiment, the strain detection unit 7 can accurately detect the change in the axial force of the shank 2, whereby the fastened state of the bolt 21 can be accurately confirmed. The flange 6 can be easily formed in the head 3, whereby the bolt 21 that can have the fastened state accurately confirmed and involves no complex operation, long operation time, or high cost.

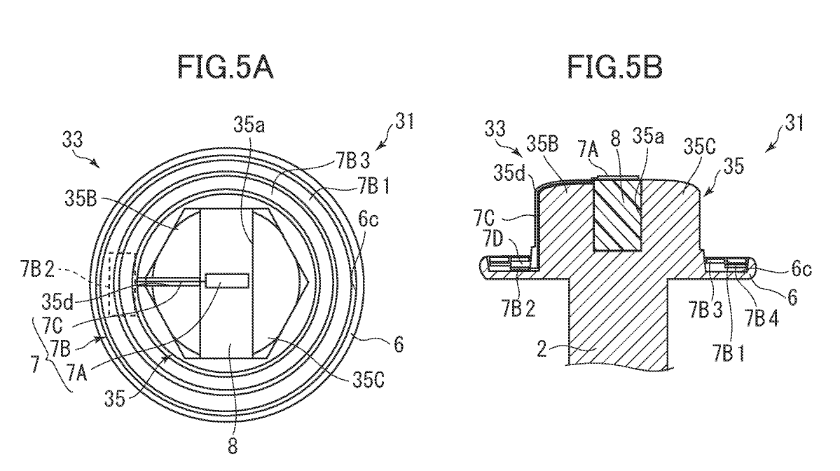

Next, a bolt 31 according to a third embodiment of the present invention will be described. Components that are the same as the counterparts in the first embodiment are denoted with the same reference numerals, and the description thereof is omitted. Thus, only the difference will be described. FIG. 5A is a top view of the bolt 31 according to the third embodiment, and FIG. 5B is a cross-sectional view of a portion around a head 33 of the bolt 31 according to the third embodiment.

The head 33 includes a head main body 35 having a hexagonal pillar shape and the flange 6. A groove 35a is formed in the head main body 35, and extends across one side surface of the hexagonal pillar and the other side surface on the opposite side of the one side surface. Thus, the head main body 35 includes two protrusions 35B and 35C facing each other in the radial direction of the shank 2. A connecting groove 35d that connects between the groove 35a and an annular groove 6c described later is formed on the protrusion 35B. A resin piece 8, having a smaller value of Young's modulus than the head main body 35 made of a steel material, is embedded in the groove 35a. The resistance strain gauge 7A is adhered on a surface of the resin piece 8 with adhesive. The resin piece 8 corresponds to the deformed portion.

The annular groove 6c is formed over the entire circumference of the flange 6. The output circuit 7B is fixed to the annular groove 6c with adhesive. The output circuit 7B includes the power reception coil 7B1 in an annular form, the transmission circuit 7B2, the transmission antenna 7B3 in an annular form, and the magnetic force blocking plate 7B4 in an annular form that are integrated by a resin piece 7D. The resistance strain gauge 7A and the transmission circuit 7B2 are connected to each other via the signal line 7C routed along the connecting groove 35d.

In the present embodiment, as in the case of the bolt 1 according to the embodiment described above, in a state where the fastened object is fastened by the bolt 31, the head 33 is pulled toward the fastened object by the axial force of the shank 2. As a result, a bottom portion of the groove 35a and the flange 6 largely deform, in such a manner that free ends of the protrusions 35B and 35C are displaced to be closer to each other. More specifically, the protrusions 35B and 35C are inclined such that the free ends thereof move closer to each other. The free ends of the protrusions 35B and 35C are positioned far from the bottom portion of the groove 35a and the flange 6, and thus their displacement is larger than the deformation (displacement) of the bottom portion of the groove 35a and the flange 6.

The displacement of the protrusions 35B and 35C causes a bulging deformation of the resin piece 8 embedded in the groove 35a. The resin piece 8 has a smaller value of Young's modulus than the head main body 35 made of a steel material, and is pressed from both sides, and thus its deformation is larger than the displacement of the protrusions 35B and 35C. Thus, the resin piece 8 functions as the deformed portion and is more deformed than other portions of the bolt 31. The resistance strain gauge 7A detects the strain on the resin piece 8 as the resistance. As in the first embodiment, a magnetic field toward the output circuit 7B disposed on the flange 6 is generated by the measurement device 200, and the output circuit 7B outputs a signal corresponding to the resistance of the resistance strain gauge 7A, whereby the resistance of the resistance strain gauge 7A is detected.

As in the case of the bolt 1 according to the first embodiment, in the bolt 31 according to the present embodiment, the strain detection unit 7 can accurately detect the change in the axial force of the shank 2, whereby the fastened state of the bolt 31 can be accurately confirmed. Furthermore, with the resin piece 8 that can deform more than the flange 6 and the bottom plate 5C, the change in the axial force of the shank 2 can be more accurately detected compared with the embodiments described above.

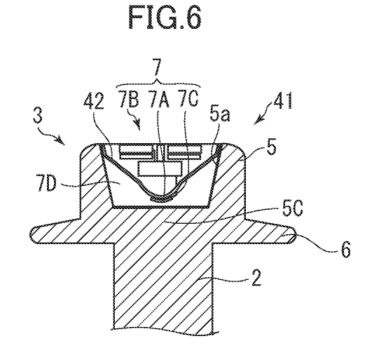

Next, a bolt 41 according to a fourth embodiment of the present invention will be described. Components that are the same as the counterparts in the first embodiment are denoted with the same reference numerals, and the description thereof is omitted. Thus, only the difference will be described. FIG. 6 is a cross-sectional view of a portion around the head 3 of the bolt 41 according to the fourth embodiment.

The head 3 includes a leaf spring 42 having a smaller value of Young's modulus than the recessed portion 5. The leaf spring 42 has both ends disposed on respective free ends of the recessed portion 5. The resistance strain gauge 7A is adhered on a center portion of the leaf spring 42 with adhesive. The leaf spring 42 corresponds to the deformed portion. The leaf spring 42 and the strain detection unit 7 are integrated by the resin piece 7D, and are fixed on the recess 5a with adhesive.

Also in the present invention, as in the case of the bolt 1 in the embodiment described above, the head 3 is pulled toward the fastened object by the axial force of the shank 2, in a state where the fastened object is fastened by the bolt 41. As a result, the bottom plate 5C and the flange 6 largely deform to cause displacement (deformation) of the free ends of the recessed portion 5 toward the center axis of the shank 2. Due to the displacement (deformation) of the free ends of the recessed portion 5, both ends of the leaf spring 42 are pressed to move closer to each other and the leaf spring 42 is thereby deformed. The leaf spring 42 has a smaller value of Young's module than the head 3 made of a steel material, and is deformed such that both ends of the leaf spring 42 move closer to each other. Accordingly, the leaf spring 42 is more deformed than the recessed portion 5. Thus, the leaf spring 42 is disposed in the recessed portion 5 in such a manner as to deform in accordance with the deformation of the recessed portion 5.

The resistance strain gauge 7A detects the strain on the center portion of the leaf spring 42. As in the first embodiment, a magnetic field toward the output circuit 7B disposed on the flange 6 is generated by the measurement device 200, and the output circuit 7B outputs a signal corresponding to the resistance of the resistance strain gauge 7A, whereby the resistance of the resistance strain gauge 7A is detected.

As in the case of the bolt 1 according to the first embodiment, in the bolt 41 according to the present embodiment, the strain detection unit 7 can accurately detect the change in the axial force of the shank 2, whereby the fastened state of the bolt 41 can be accurately confirmed.

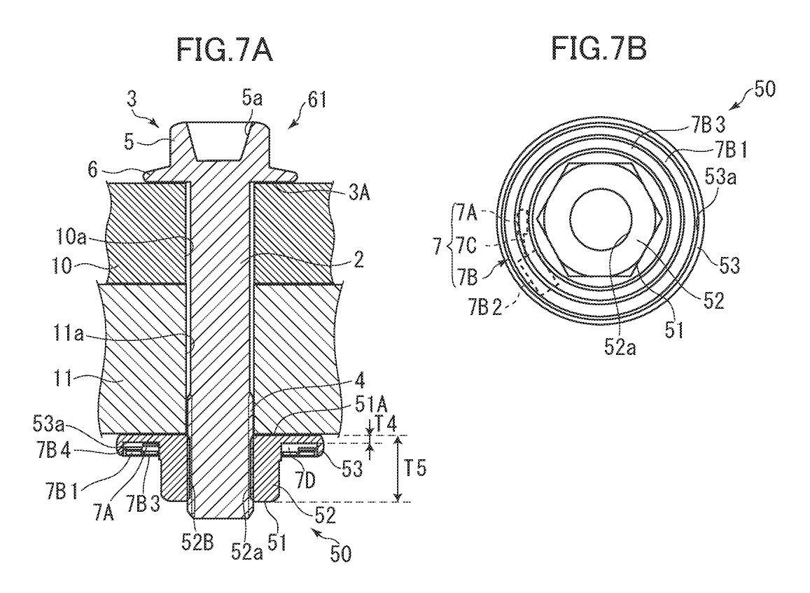

Next, a nut 50 according to a fifth embodiment of the present invention will be described. Components that are the same as the counterparts in the first embodiment are denoted with the same reference numerals, and the description thereof is mitted. Thus, only the difference will be described. FIG. 7A illustrates a state where an fastened object is fastened by the nut 50 and a bolt 61 according to the fifth embodiment. FIG. 7B is a top view of the nut 50 according to the fifth embodiment.

The nut 50 is made of a steel material, and includes a nut main body 51 and the strain detection unit 7. The nut main body 51 includes a cylindrical portion 52 having a hexagonal shape and a flange 53. The nut main body 51 further includes a contact surface 51A that comes into contact with the fastened object. A third insertion hole 52a is formed in the cylindrical portion 52. A female screw 52B is formed on an inner circumference surface of the cylindrical portion 52 defining the third insertion hole 52a.

The flange 53 is disposed on an outer circumference of the cylindrical portion 52 and radially extends from the outer circumference of the cylindrical portion 52 in a radial direction. An annular groove 53a is formed over the entire circumference of the flange 53. The flange 53 has a portion where the resistance strain gauge 7A is adhered. This portion has a thickness T4 that is smaller than a largest thickness T5 of the nut main body 51. The flange 53 corresponds to the deformed portion.

The strain detection unit 7 is disposed in the annular groove 53a. The resistance strain gauge 7A is adhered on the bottom surface of the annular groove 53a with adhesive, and detects strain on the flange 53. The resistance strain gauge 7A, the output circuit 7B, and the signal line 7C are integrated by the resin piece 7D, and is fixed on the annular groove 53a with adhesive. The power reception coil 7B1, the transmission antenna 7B3, and the magnetic force blocking plate 7B4 are in an annular form and are disposed in the annular groove 53a. The resistance strain gauge 7A and the transmission circuit 7B2 are connected to each other via the signal line 7C.

The bolt 61 according to the present embodiment has a configuration similar to that of the bolt 1 according to the first embodiment. However, there is a difference in that the bolt 61 includes no strain detection unit.

In the present embodiment, the shank 2 of the bolt 61 is inserted into the first and the second insertion holes 10a and 11a. The male screw 4 of the bolt 61 and the female screw 52B of the nut 50 are screwed together. In this manner, the first and the second objects to be fastened 10 and 11 are fastened by the bolt 61 and the nut 50.

In the state where the first and the second fastened objects 10 and 11 are fastened by the bolt 61 and the nut 50, the contact surface 3A of the head 3 presses the first fastened object 10, and the contact surface 51A of the nut main body 51 presses the second fastened object 11, and thus the head 3 receives the counter force from the first fastened object 10 and the nut main body 51 receives the counter force from the second fastened object 11. Thus, the axial force is produced in the shank 2. The nut main body 51 is pulled toward the second fastened object 11 by the axial force. As a result, the stress is concentrated on the flange 53 having a thickness smaller than the largest thickness T5 of the nut main body 51. Thus, the flange 53 deforms more than other portions of the nut main body 51. In other words, the stress based on the axial force of the shank 2 is concentrated on the flange 53 as the deformed portion, and thus the flange 53 is deformed more than the other portions of the nut main body 51.

The resistance of the resistance strain gauge 7A changes in accordance with the strain on the flange 53. The initial resistance of the resistance strain gauge 7A after the fastening is detected with the electric signal corresponding to the resistance of the resistance strain gauge 7A output from the output circuit 7B. In this manner, the strain on the flange 53 is detected as the resistance by the strain detection unit 7.

Also in the present embodiment, whether the bolt 61 and the nut 50 are appropriately fastened can be determined by detecting the resistance of the resistance strain gauge 7A after a predetermined period of time has elapsed after the first and the second fastened objects 10 and 11 have been fastened by the bolt 61 and the nut 50. Also in the nut 50 according to the present embodiment, the strain detection unit 7 can accurately detect the change in the axial force of the shank 2, whereby the fastened state of the bolt 61 and the nut 50 can be accurately confirmed. The flange 53 can be easily formed on the nut main body 51. Thus, the nut 50 that can have the fastened state accurately confirmed and involves no complex operation, long operation time, or high cost can be obtained.

The embodiments of the present invention described above are examples for describing the present invention. Thus, there is no intension to limit the scope of the present invention to the embodiments. A person skilled in the art can implement the present invention in various modes without departing from the gist of the present invention.

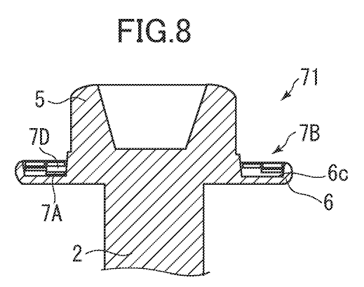

For example, as in a bolt 71 illustrated in FIG. 8, the strain detection unit 7 including the resistance strain gauge 7A, the output circuit 7B, and an unillustrated signal line may be disposed in the annular groove 6c formed on the flange 6. In this case, the resistance strain gauge 7A, the output circuit 7B, and the signal line are integrated by the resin piece 7D, and are fixed on the annular groove 6c with adhesive. Alternatively, the strain detection unit 7 may include: the resistance strain gauge 7A adhered on the flange 6 without the annular groove 6c; and the annular output circuit 7B, formed as an integrated unit by a resin piece, disposed thereon.

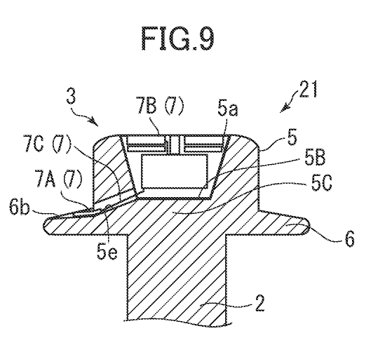

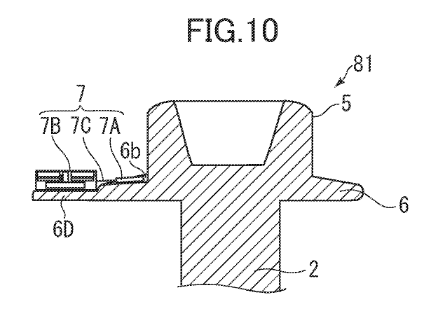

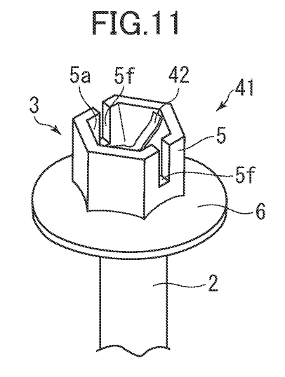

In the second embodiment, the signal line 7C is routed along the connecting groove 5d of the recessed portion 5. Alternatively, a through hole 5e may be formed in the recessed portion 5, and the signal line 7C may be routed in the through hole 5e, as illustrated in FIG. 9. As in a bolt 81 illustrated in FIG. 10, an extension portion 6D may be formed at a part of an outer edge of the flange 6, and the output circuit 7B may be disposed in the extension portion 6D. As illustrated in FIG. 11, in the bolt 41 according to the fourth embodiment, a slit 5f may be formed on one side wall of the recessed portion 5 having a hexagonal pillar shape and on the other side wall positioned on the opposite side of the one side wall. With this configuration, the free ends of the recessed portion 5 can be more largely displaced, whereby the deformation of the leaf spring 42 can be increased. As a result, the resistance strain gauge 7A can have higher sensitivity against the change in the axial force, whereby the fastened state of the bolt 1 can be more accurately confirmed. In FIG. 11, only the leaf spring 42 is illustrated, and the strain detection unit 7 is omitted.

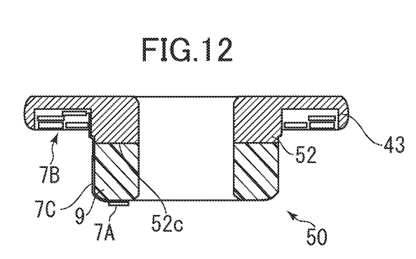

Furthermore, as illustrated in FIG. 12, a slit 52c that extends across one side surface of the hexagonal pillar and the other side surface at a position on the opposite side of the one side surface may be formed in the cylindrical portion 52 of the nut 50. A resin piece 9, having a smaller value of Young's modulus than the cylindrical portion 52 made of a steel material, may be embedded in the slit 52c. The resistance strain gauge 7A may be adhered on the resin piece 9, and as in the bolt 31 according to the third embodiment, may detect the axial force of the shank 2 by detecting the strain on the resin piece 9. In the first embodiment, the first and the second fastened objects 10 and 11 are fastened by the bolt 1 with the male screw 4 of the bolt 1 and the female screw 11B of the second fastened object 11 screwed together. Alternatively, a nut may be provided on a side of the second fastened object 11 opposite to a side that comes into contact with the first fastened object 10 instead of providing the female screw 11B on the second fastened object 11. Thus, the first and the second fastened objects 10 and 11 may be fastened by the bolt 1 and the nut, with the nut and the bolt 1 screwed together.

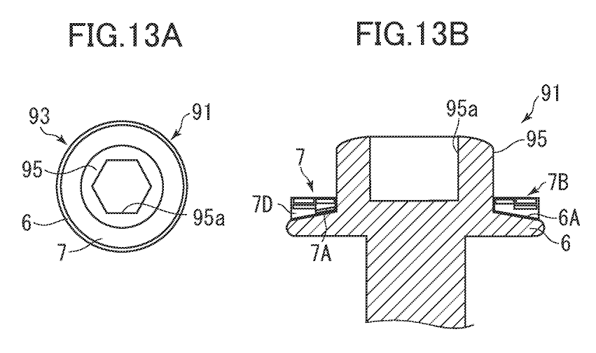

In the first embodiment, the recessed portion 5 has a hexagonal outer circumference shape. Alternatively, a recessed portion 95 of a head 93 of a bolt 91 may have a circular outer circumference shape, and have a hexagonal inner circumference shape (recess 95a), as illustrated in FIG. 13A. In such a case, as illustrated in FIG. 13B, the strain detection unit 7 is disposed on the flange 6. For example, the resistance strain gauge 7A is adhered on the opposite surface 6A of the flange 6 with adhesive, and detects the strain on the flange 6. The resistance strain gauge 7A is preferably adhered on a portion around a boundary between the recessed portion 95 and the flange 6, and may be adhered on both the recessed portion 95 and the flange 6. The resistance strain gauge 7A, the output circuit 7B, and an unillustrated signal line are integrated with the resin piece 7D, and are fixed on the opposite surface 6A of the flange 6 with adhesive. When the fastened object is fastened by the bolt 91, a fastening tool, having an outer circumference shape corresponding to the inner circumference shape of the recess 95a of the recessed portion 95, is inserted into the recess 95a and rotates the bolt 91. The inner circumference shape of the recess 91a is not limited to the hexagonal shape, and may be a dodecagonal shape or a hexalobular shape.

The flange 6 may be formed independently from the recessed portion 5 and may be made of a material having a smaller value of Young's modulus than the recessed portion 5. The strain detection unit 7, described above as the foil gauge, may be a semiconductor gauge. Furthermore, the resistance strain gauge may be formed on the bottom plate 5C and the flange 6 by printing.

In the embodiments described above, the strain detection unit 7 detects the strain with the resistance strain gauge 7A. However, this should not be construed in a limiting sense. The bottom plate 5C and the flange 6 or 53 may be coated with a stress analysis coating, and the axial force of the shank 2 may be detected by detecting the strain from a crack on the surface. Furthermore, a film made of a photoelastic material may be attached on the bottom plate 5C and the flange 6 or 53, and the axial force of the shank 2 may be detected by detecting the strain through observation of a stripe pattern obtained by irradiating the film with linearly polarized light. The photoelastic material may be formed on the bottom plate 5C and the flange 6 or 53 by printing. Moreover, the axial force of the shank 2 may be detected through a magnetostrictive stress measurement method. More specifically, the axial force of the shank 2 may be detected by comparing the magnetic permeability at the bottom plate 5C and the flange 6 or 53 with the magnetic permeability at a portion of the head 3 where the deformation is less likely to occur. In addition, although the output circuit 7B has been configured to supply current through the power reception coil 7B1 and output the strain through the transmission antenna 7B3, the present invention is not limited thereto and the strain detection unit 7 may have any other configuration as long as it can output the strain.

What is claimed is:

1. A bolt comprising:
a shank;
a head that is disposed on one end of the shank, and includes a deformed portion that has a smaller thickness in an axial direction of the shank or a smaller value of Young's modulus than other portion of the head, and that is configured to be deformed more than the other portion by axial force of the shank; and
a detection unit that is configured to detect strain on the deformed portion depending on the axial force of the shank,
wherein the deformed portion includes a thin portion that has a thickness smaller than a largest thickness of the head in the axial direction of the shank,
the head includes a recessed portion having a bottom plate serving as the thin portion, the bottom plate being positioned on an axis of the shank, and
the detection unit is positioned on the axis of the shank and is configured to detect strain on the bottom plate.

2. A bolt comprising:
a shank;
a head that is disposed on one end of the shank, and includes a deformed portion that has a smaller thickness in an axial direction of the shank or a smaller value of Young's modulus than other portion of the head, and that is configured to be deformed more than the other portion by axial force of the shank; and
a detection unit that is configured to detect strain on the deformed portion depending on the axial force of the shank,
wherein the deformed portion includes a thin portion that has a thickness smaller than a largest thickness of the head in the axial direction of the shank,
the head includes a flange that serves as the thin portion, extends in a radial direction of the shank, and has an opposite surface positioned on a side opposite to a contact surface that comes into contact with an object to be fastened, and
the detection unit is configured to detect strain on the opposite surface of the flange.

3. A bolt comprising:
a shank;
a head that is disposed on one end of the shank, and includes a deformed portion that has a smaller thickness in an axial direction of the shank or a smaller value of Young's modulus than other portion of the head, and that is configured to be deformed more than the other portion by axial force of the shank; and
a detection unit that is configured to detect strain on the deformed portion depending on the axial force of the shank,
wherein the head includes a recessed portion,
the deformed portion is a leaf spring as a portion provided independently from the recessed portion and having the small value of Young's modulus, and is disposed in the recessed portion in such a manner as to be deformed in accordance with deformation of the recessed portion, and
the detection unit is configured to detect strain on the leaf spring.

4. The bolt according to claim 1,
wherein the detection unit includes:
a power reception unit that is configured to generate power in accordance with a magnetic flux provided from a measurement device;
a strain detection element that is configured to change an electrical characteristic in accordance with the strain; and
a transmission unit that is configured to be operated by the power supplied from the power reception unit, generate a signal corresponding to the electrical characteristic, and wirelessly transmit the signal to the measurement device.

5. The bolt according to claim 4,
wherein the strain detection element is a resistance strain gauge, and
the signal has a frequency corresponding to a resistance of the resistance strain gauge.

6. The bolt according to claim 5,
wherein the detection unit further includes a temperature measurement unit that is configured to measure temperature, and
the transmission unit is configured to switch between the resistance strain gauge and the temperature measurement unit to generate the signal indicating the resistance of the resistance strain gauge and the temperature.

7. The bolt according to claim 6,
wherein the detection unit further includes an identification information storage unit that is configured to store identification information of the bolt, and
the transmission unit is configured to switch among the resistance strain gauge, the temperature measurement unit, and the identification information storage unit to generate the signal indicating the resistance of the resistance strain gauge, the temperature, and the identification information.

8. A nut comprising:
a nut main body that is fastened to a fastening bolt including a shank, and includes a deformed portion that has a smaller thickness in an axial direction of the nut main body or a smaller value of Young's modulus than other portion of the nut main body, and that is configured to be deformed more than the other portion by axial force of the shank; and
a detection unit that is configured to detect strain on the deformed portion corresponding to the axial force of the shank.

9. A strain measurement system comprising:
the bolt according to claim 1; and
a measurement device that is configured to generate a magnetic flux and receive a wireless signal,
wherein the detection unit includes:
a power reception unit that is configured to generate power in accordance with the magnetic flux;
a strain detection element that is configured to change an electrical characteristic in accordance with the strain; and
a transmission unit that is configured to be operated by the power, generate a signal corresponding to the electrical characteristic, and wirelessly transmit the signal to the measurement device, and
the measurement device includes:
a power transmission unit that is configured to transmit power to the power reception unit by varying the magnetic flux; and
a power reception unit that is configured to wirelessly receive the signal from the transmission unit.

10. A strain measurement system comprising:
the bolt according to claim 2; and
a measurement device that is configured to generate a magnetic flux and receive a wireless signal,
wherein the detection unit includes:
a power reception unit that is configured to generate power in accordance with the magnetic flux;
a strain detection element that is configured to change an electrical characteristic in accordance with the strain; and
a transmission unit that is configured to be operated by the power, generate a signal corresponding to the electrical characteristic, and wirelessly transmit the signal to the measurement device, and
the measurement device includes:
a power transmission unit that is configured to transmit power to the power reception unit by varying the magnetic flux; and
a power reception unit that is configured to wirelessly receive the signal from the transmission unit.

11. A strain measurement system comprising:
the bolt according to claim 3; and
a measurement device that is configured to generate a magnetic flux and receive a wireless signal,
wherein the detection unit includes:
a power reception unit that is configured to generate power in accordance with the magnetic flux;
a strain detection element that is configured to change an electrical characteristic in accordance with the strain; and
a transmission unit that is configured to be operated by the power, generate a signal corresponding to the electrical characteristic, and wirelessly transmit the signal to the measurement device, and
the measurement device includes:
a power transmission unit that is configured to transmit power to the power reception unit by varying the magnetic flux; and
a power reception unit that is configured to wirelessly receive the signal from the transmission unit.
